(19) United States
(12) Patent Application Publication
(10) Pub. No.: US 2002/0067038 A1
(43) Pub. Date: Jun. 6, 2002

(54) Tissue box cover

(76) Inventor: Lam H. Tran, Westminster, CA (US)

Correspondence Address: Charles H. Thomas, CISLO & THOMAS LLP, 4201 Long Beach Blvd., Suite 405, Long Beach, CA, 90807-2022, US

(21) Appl. No.: 09/848,042

(22) Filed: May 4, 2001

Related U.S. Application Data
(63) Continuation-in-part of application No. 09/728,386, filed on Dec. 4, 2000.

(51) Int. Cl. B42D 3/00

(52) U.S. Cl. 281/29

(57) ABSTRACT

A tissue box cover having a top with a tissue access opening defined therethrough and flat, surrounding depending side walls provided to house a conventional cardboard box of facial tissue. A display opening is defined in at least one of the side walls of the tissue box cover. A blister formed of stiff, resilient, transparent material having a base, a raised interior bubble portion projecting outwardly from the base, and flat base flanges projecting in opposing lateral directions from the bubble portion is mounted in each display opening. The bubble portion of the blister projects into the display opening from the inside surface of the tissue box cover side walls. An ornamental object is positioned in the enclosure defined by the bubble portion of the blister. This enclosure is closed from the inside by a backing plate panel, and preferably also a decorative support panel sandwiched in between the backing plate panel and the base of the blister. The tissue box cover is preferably formed with display openings and transparent enclosures in all of its upright side walls. The enclosing portion of the tissue box cover is preferably mounted atop a turntable that rotates about a vertical axis relative to a stationary support.

The present invention is a continuation in part of U.S. application Ser. No. 09/728,386 filed Dec. 4, 2000, presently pending.

### BACKGROUND OF THE INVENTION

1. Field of the Invention

The present invention relates to tissue box covers of the type utilized to house the cardboard boxes in which facial tissue is sold.

2. Description of the Prior Art

For many years facial tissues have been packed tightly and sold in cardboard boxes for use by consumers. The basic cardboard packaging in which facial tissues are packed and sold is not particularly aesthetically appealing to many consumers. As a consequence, many consumers purchase tissue cover boxes that slip over the basic cardboard boxes in which facial tissue is sold. Conventional tissue cover boxes of this type have a much greater aesthetic appeal and are typically sturdier than a cardboard box.

A conventional tissue box cover is typically a hollow structure formed in the shape of a rectangular prism, often having an open bottom. Tissue box covers of this type are often formed of either wood, cardboard, or plastic. Very frequently the bottom opening is provided with a bottom closure panel that may be releaseably secured in place to the lower extremities of the upright side walls of the box. The top of the tissue box cover is provided with an access opening that aligns with the corresponding tissue withdrawal or extraction opening defined in the top of a cardboard box of facial tissues.

When the tissue box cover is first placed over the cardboard box of tissues the user reaches through the top access opening in the tissue box cover and pulls a facial tissue out through the withdrawal opening defined in the top of the cardboard box and also through the top access opening in the tissue box cover. Facial tissues are packed so that thereafter the next facial tissue is drawn partially out through the top of the cardboard tissue box and the top access opening in the tissue box cover when the immediately preceding facial tissue is withdrawn for use.

There are many different styles and designs of tissue box covers that have aesthetic appeal for different people. Some tissue box covers are formed as soft, fabric casings that are pulled over the top of a cardboard tissue box. Other tissue box covers are formed with a relatively rigid frame covered by a fabric or a knit jacket. Still other tissue box covers are formed with a hard, opaque outer surface decorated to the aesthetic taste of the user.

### SUMMARY OF THE INVENTION

The present invention is a tissue box cover that is constructed in a unique manner. More specifically, at least one display opening is defined through at least one of the upright side walls of the tissue box cover. Each display opening is preferably completely surrounded by the structure of the side wall of the box in which the opening is formed. A blister formed of a stiff, resilient, transparent material and having a base, a raised interior bubble portion projecting out from the base, and flat base flanges projecting in opposing lateral directions from the base of the bubble portion is provided for each display opening.

The bubble portion of the blister has a size only slightly smaller than the display opening. The bubble portion of the blister projects into the display opening from the inside surface of the tissue box cover side wall in which the display opening is formed. The base flanges of the blister reside in contact with and are secured to the inside surface of the side wall of the tissue box cover. Also, a base closure member extends across the base of the blister to define a hollow, shallow cavity within the bubble portion of the blister.

Although of only limited depth, the cavity formed between the base closure member and the bubble portion of the blister is deep enough to accommodate a selected display ornament, such as a pressed flower, a photograph, or some other relatively thin decorative or ornamental article. In a preferred embodiment of the invention both the display opening and the bubble portion of the blister have a rectangular shape, which may be square. Also, the ornamental article located in the cavity may be supported from behind by a flat upright base closure panel member constructed of decorative paper or card stock. Alternatively, the decorative base closure panel can be formed as a part of the ornamental object itself.

In another aspect the invention may be considered to be a tissue box cover having a top with a tissue access opening defined therethrough and upright surrounding walls depending from the top to surround a tissue box enclosure. At least one display opening is defined entirely through at least one of the upright walls. A separate transparent flanged window is located in each of the display openings. Each flanged window has a raised interior bubble portion surrounded by a base having a periphery with at least one mounting flange projecting laterally from opposing sides of the periphery of the base. The flanged windows are secured to the inside surfaces of the tissue box cover side walls in which the display openings are formed. Backing plates are disposed across the bases of the flanged windows to define separate, hollow enclosed cavities within the bubble portions of each of the windows.

These enclosed cavities serve to house ornamental objects which are mounted for display therewithin. The flanged windows form display boxes and are preferably constructed of transparent plastic. The bubbles are preferably shaped so that each of the enclosed cavities is formed as a thin rectangular prism. The ornamental objects housed in the display box cavities may be either two-dimensional or three-dimensional. The ornamental objects may be anchored in position within the cavities. Alternatively, they may be entrapped loosely within the confines of the hollow cavities.

The invention may also be considered to be a tissue box cover formed with a top having a tissue access opening defmed therethrough and upright, surrounding walls having inside and outside surfaces. At least one display opening is defined through at least one of the surrounding walls. A shallow transparent tray defining a display panel, surrounding sides, and laterally projecting feet extending away from the sides is provided for each display opening. Each transparent tray is positioned in its display opening with its display panel located proximate the outside surface of a side wall and with its feet located in contact with the inside surface of the wall. A backing plate extends across the tray and resides in contact with the inside surface of said wall to thereby define a hollow, encapsulated cavity bounded by the display panel of the transparent tray and the surrounding sides of said tray. The backing plate may be either permanently sealed to the inside surface of the region of the wall surrounding the display opening, or it may be releaseably secured to the inside surface of that wall of the tissue box cover.

In a preferred embodiment of the invention display openings are defined in each of several of the upright tissue box cover side walls. Indeed, display openings with transparent trays mounted therein may be provided for all of the upright walls of the tissue box cover. Also, the tissue box cover is preferably provided with a bottom closure. This bottom closure may take the form of a mounting stand that includes a platform or turntable mounted for rotation atop a stationary support.

The invention may be described with greater clarity and particularity by reference to the accompanying drawings.

### DESCRIPTION OF THE DRAWINGS

FIG. 1 is a perspective view of one preferred embodiment of a tissue box cover constructed according to the invention.

FIG. 2 is a side elevational sectional view of the tissue box cover shown in FIG. 1.

FIG. 3 is an exploded, perspective view illustrating a single display tray or blister structure with an ornamental, three-dimensional article positioned within its confines.

### DESCRIPTION OF THE EMBODIMENT

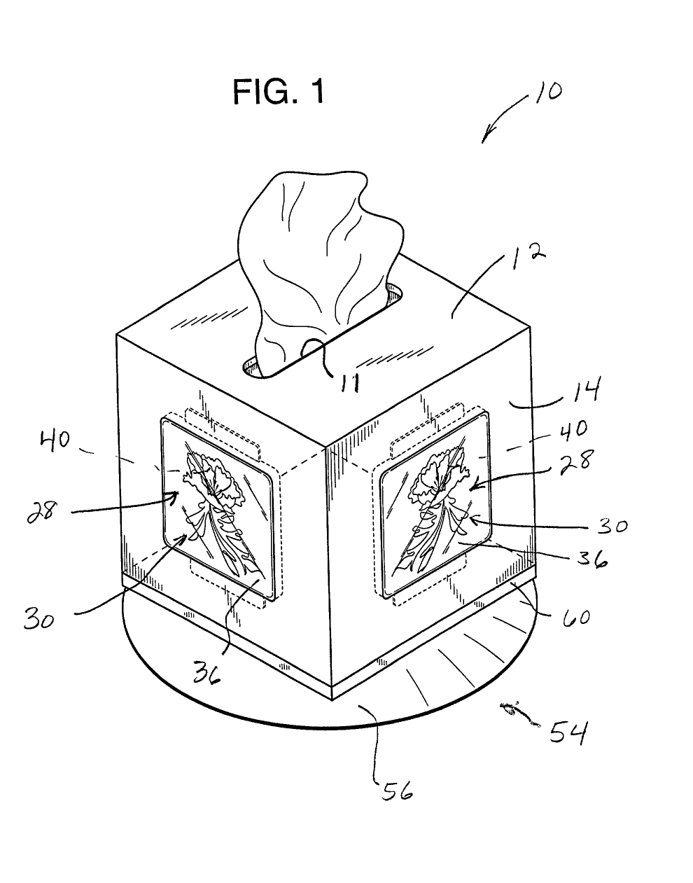

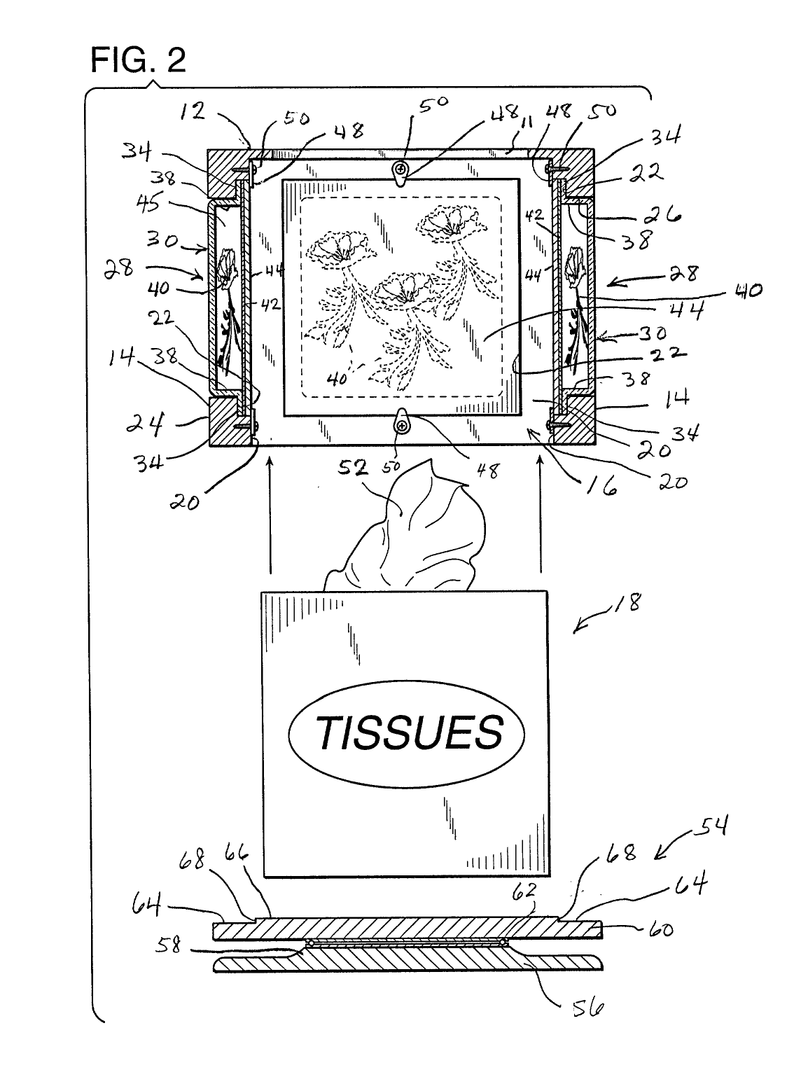

FIG. 1 illustrates a hollow, wooden tissue box cover 10 having a generally cubical configuration. The tissue box cover 10 has a flat roof 12 having a square perimeter and defining a narrow, oblong tissue access opening 11 through its structure. The tissue box cover 10 has four upright, square walls 14 that are oriented perpendicular to the roof 12. The walls 14 extend downwardly from the roof 12 to define a cubical tissue box enclosure 16 that has dimensions that conform to, but which are slightly larger than a standard, cubicle cardboard tissue box 18, such as that visible in FIG. 2.

Each of the tissue box cover side walls 14 has an inner surface 20 and an outer surface 24, as illustrated in FIG. 2. A relatively large, square display opening 26 is defined through the structure of each of the upright tissue box cover side walls 14. In the embodiment illustrated, there are four separate display openings 26, a separate display opening 26 being defined through each of the upright side walls 14 in an aesthetically appealing manner, as illustrated in the drawing figures. A recessed, bearing ledge 22 is formed in the inside surface 20 of each of the side walls 14 about the periphery of the display opening 26 defined therewithin

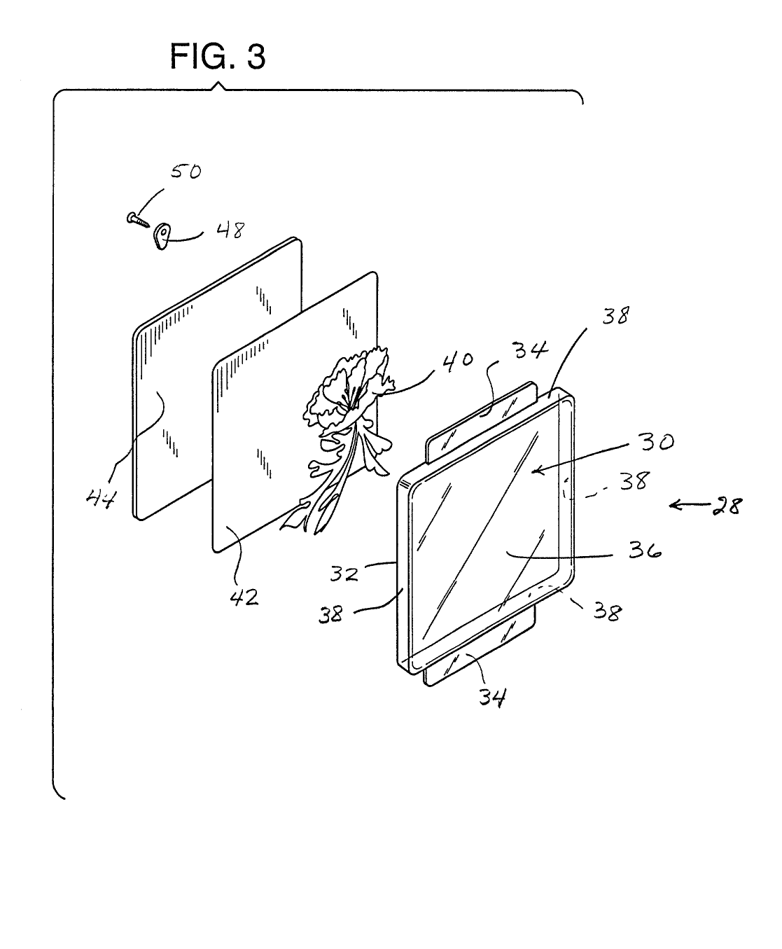

A separate, transparent plastic blister or flanged window 28 is located in each of the display openings 26. As illustrated in FIG. 3, each of the transparent blisters 28 has a raised, interior bubble portion 30 surrounded by a base 32. The base 32 must have at least one mounting flange projecting laterally from opposite sides of its periphery. In the embodiment illustrated, the base 32 has a short, flat mounting flange or foot 34 projecting laterally outwardly away from the bubble 30 from two opposing sides 38 of the blister 28, as best illustrated in FIG. 3. The bubble portion 30 of each blister or flanged window 28 is formed as a shallow, transparent tray defining a display panel 36 and walls 38. The laterally projecting planar flanges or feet 34 extend away from the blister walls 36 at the base 32 in a plane parallel to that of the display panel 36.

The raised, interior bubble portion 30 of each blister 28 projects into and is located within the surrounding confines of a separate one of the display openings 26 in the walls 14 of the tissue box cover 10, as illustrated in FIGS. 1 and 2. Each of the display windows or blisters 28 is formed of a stiff, transparent plastic material, such as polypropylene or polyethylene, or it can be fabricated by injection molding. The windows or blisters 28 may be shaped so that each of the enclosed cavities defined therewithin has the shape of a shallow, rectangular prism.

In the embodiment illustrated, each blister 28 is formed with a substantially square exposed display panel 36 surrounded by four short walls 38 that extend from the display panel 36 to the base 32. The walls 38 of the blister 28 are oriented perpendicular to the plane of the tissue box cover wall 14 in which the blister 28 is mounted and have a length as measured between the base 32 and the display panel 36 equal to the distance between the outer surface 24 of the wall 14 of the tissue box cover 10 and the bearing ledge 22 surrounding the display opening 26. As a consequence, the display panel 36 of each blister 28 resides in the same plane as the outside surface 24 of the tissue box cover side wall 14 in which the blister 28 is mounted

The dimensions of the bubble portions 30 of the blisters 28 closely conform to the dimensions of the display openings 26. As a consequence, the sides 38 of the bubble portions 30 of the blisters 28 fit snugly into the confines formed by the display openings 26. A fairly secure frictional fit is thereby established that holds the blisters 28 in position within the display openings 26 with the bubble portions 30 projecting outwardly into the display openings 26. Alternatively, or in addition, the blister feet 34 may be secured by adhesive to the bearing recesses 22.

In the embodiment of FIGS. 1-3, a three-dimensional object, for example a dried flower 40, is placed within each of the bubble portions 30 of the blisters 28. At this point in the fabrication of the tissue box cover 10 a flat, square, decorative paper or plastic support sheet or panel 42 is placed behind the flower display ornament 40 in contact with and closing the base 32 of each blister 28. The mounting flanges 34 are pressed against the flat bearing faces of the bearing recesses 22. The periphery of the support sheet 42 contacts the base 32 of the blister 28 and thereby encapsulates the dried flower 40 within the enclosure 45 defined between the structure of the blister 28 and the support sheet 42. The support sheet 42 thereby serves the function of a blister or window base closure so that separate, hollow, enclosed cavities 45 are formed within the interiors of each of the bubble portions 30.

A square backing plate 44 is then laid across the surface of the support sheet 42 that faces away from the blister 28. The backing plate 44 is completely removable from the side wall 14 to allow removal of the support panel 42 and the decorative article 40. Removal of the backing plates 44 and the support panels 42 allows full exposure of the tray-like structures formed by the blisters 28 located in the display openings 26 in the tissue box cover side walls 14. The raised, interior bubbles 30 project into the display openings 26 and the backing plates 44 are disposed across the bases 32 of the blisters or flanged windows 28, flush with the inside surfaces 20 of the tissue box cover side walls 14.

For some embodiments it is advantages to seal the support panel 42 to the edges of the base 32. For example, the blister 28 may be partially or completely filled with water surrounding the article 40. In this case the support panel 42 should be sealed with a watertight adhesive to the edges of the base 32.

Each of the backing plates 44 is held in position in a bearing recess 22 surrounding a display opening 26 by swivel locking tabs 48. The swivel locking tabs 48 are small, flat structures that have openings formed therethrough at one end. These openings received the shanks of wood screws 50 that project through the inner surfaces 20 and into the structures of the tissue box side walls 14. The swivel locking tabs 48 are rotated about the shanks of the screws 50 clear of the backing plates 44 to allow removal of the backing plates 44 and the support panels 42. This is done to change the decorative articles that are positioned in the boxes 28. Once the decorative articles 40 have been changed, the support panels 42 are returned to their positions against the bases 32 of the blisters 28. The backing plates 44 are then once again positioned in the peripheral bearing ledge recesses 22, flush with the inner surfaces 20 of the tissue box cover side walls 14 and against the support panels 42.

As illustrated in FIG. 2 the tissue box cover 10 can be lowered onto or lifted from a conventional, cubical cardboard tissue box 18. The heads of the swivel tab screws 50 have a low enough profile to clear the outside surfaces of the tissue box 18. The tissue access opening 11 defined in the top 12 of the tissue box cover 10 is aligned with the conventional tissue extraction slot formed in the top of the tissue box 18. This alignment allows tissues 52 that project upwardly through the extraction slot in the top of the tissue box 18 to be easily withdrawn for use through the access opening 11 defined in the tissue box cover 10.

In the embodiment of the invention illustrated the tissue box cover 10 is also comprised of a mounting support stand 54. The mounting support stand 54 includes a low, flat, generally disk-shaped stationary member 56 having a raised mounting pedestal 58 at its center. Atop the mounting pedestal 58 there is a flat platform 60 rotatably and coaxially mounted relative to the central pedestal 58. The platform 60 serves as a turntable and is mounted for rotation relative to the pedestal 58 by means of conventional bearings 62, as illustrated in FIG. 2.

The turntable 60 has a square outer perimeter of a size equal in area to the area covered by the tissue box cover 14. The outer periphery of the turntable 60 has a recessed, sculptured band 64 that defines a central, locator guide 66. The tissue box 18 sits atop the turntable 60 and is centered by the locator guide 66. The band 64 is of a width equal to the width of the wall thickness of the tissue box cover side walls 14, as measured between the inner surfaces 20 and outer surfaces 24 thereof. The side edges 68 of the central locator guide 66 fit snugly within the confines of the inner surfaces 20 of the side walls 14 of the tissue box cover 10 when the tissue box cover 10 is lowered onto the turntable 60. The turntable 60 thereby serves as an underlying support for the tissue box 18, while the central locator guide 66 serves as a means for centering the tissue box cover 10 when it is lowered into position onto the turntable 60.

As is evident from FIG. 1, the tissue box cover 10 provides a decorative and useful enclosure for a conventional cardboard box 18 of facial tissues 52. When the tissue box cover 10 is in position in registration atop the turntable 60, the tissues 52 can be easily withdrawn through the tissue access opening 11 in the tissue box cover roof 12. Moreover, the turntable 60 can be rotated relative to the stationary support stand 56 to allow the user to view each of the decorative articles 40 located within the transparent blisters 28 in each of the different side walls 14 of the tissue box cover 10.

Undoubtedly, numerous variations and modifications of the invention will become readily apparent to those familiar with tissue box covers. Accordingly, the scope of the invention should not be construed as limited to this specific embodiment depicted and described, but rather is defined in the claims appended hereto.

I Claim:

1. A tissue box cover having a top with a tissue dispensing opening defmed therethrough and upright walls extending downwardly from said top for surrounding a tissue box encompassed therewithin, wherein at least one of said upright walls is formed as a flat structure having inside and outside surfaces and defining at least one display opening therethrough, and a blister formed of stiff, resilient, transparent material and having a base, a raised interior bubble portion projecting outwardly from said base, and flat base flanges projecting in opposing lateral directions from said bubble portion, and said bubble portion projects into said display opening from said inside surface of said flat structure with said base flanges residing in contact with and secured to said inside surface of said flat structure, and a backing plate member extends across said base of said blister to define a hollow cavity within said bubble portion of said blister.

2. A tissue box cover according to claim 1 wherein a separate display opening as aforesaid is defined in a plurality of said upright walls, and each of said display openings is provided with a separate blister as aforesaid.

3. A tissue box cover according to claim 1 wherein said display opening and said bubble portion of said blister both have a square shape.

4. A tissue box cover according to claim 1 wherein said bubble portion projects into said display opening and reaches said outer surface of said wall in which said display opening is formed.

5. A tissue box cover according to claim 1 further comprising a base closure member that is removable from said base of said blister.

6. A tissue box cover according to claim 1 further comprising a three-dimensional object loosely entrapped in said hollow cavity.

7. A tissue box cover according to claim 1 further comprising a swivel stand.

8. A tissue box cover according to claim 7 wherein said swivel stand includes a bottom stationary element and a platform rotatable atop said stationary element about a vertical axis, and said upright walls rest upon said platform.

9. A tissue box cover defining upright walls that are laterally joined together and a top that extends across the upper ends of said walls and said top defines a tissue access opening therethrough, the improvement wherein at least one of said upright walls is formed with inside and outside surfaces and a display opening defined entirely therethrough and within the surrounding structure thereof, and a transparent flanged window is located in said display opening, and said transparent flanged window has a raised bubble portion surrounded by a base having a periphery with at least one mounting flange extending laterally from opposite sides of said periphery of said base and said transparent flanged window is secured to said upright wall so that said raised bubble projects into said display opening, and a backing plate is disposed across said base of said transparent flanged window to define a hollow enclosed cavity within said bubble portion.

10. A tissue box cover according to claim 9 wherein said flanged window is formed of a stiff plastic material and said bubble is shaped so that said enclosed cavity has the shape of a rectangular prism.

11. A tissue box cover according to claim 9 further comprising a three-dimensional object located within said hollow cavity.

12. A tissue box cover according to claim 9 wherein a three-dimensional object is loosely entrapped within the confines of said hollow cavity.

13. A tissue box cover according to claim 9 wherein said backing plate is removably secured to said inside surface of said wall.

14. A tissue box cover according to claim 9 further comprising a support stand that permits rotation of said upright walls and top about a central, vertical axis of rotation.

15. A tissue box cover according to claim 9 wherein a display opening as aforesaid is defined in each of a plurality of said upright walls, a separate flanged window is located in each of said display openings, and a flat inner closure member is disposed across said base of each of said boxes to define separate, hollow enclosed cavities within each of said bubble portions.

16. A tissue box cover according to claim 9 further comprising a swivel support including a stationary element and a mounting platform rotatable about a vertical axis relative to said stationary element and said upright walls rest atop said mounting platform.

17. A tissue box cover according to claim 9 wherein said flange at said base of said raised bubble portion is secured to said inside surface of said wall by adhesive.

18. A tissue box cover formed with a top having a tissue access opening defined therethrough and upright, surrounding walls having inside and outside surfaces, and at least one display opening defined through at least one of said surrounding walls, a shallow transparent tray defining a display panel, surrounding sides, and laterally projecting planar feet extending away from said sides, and said transparent tray is positioned in said display opening with said display panel located proximate said outside surface of said wall and with said feet located in contact with said inside surface of said wall, and a backing plate that extends across said tray and resides in contact with said inside surface of said wall thereby defining a hollow, encapsulated cavity bounded by said display panel of said transparent tray, and said surrounding sides of said tray.

19. A tissue box cover according to claim 18 further comprising a display opening formed in each of a plurality of said surrounding walls, and a separate tray as aforesaid positioned in each of said display openings as aforesaid, and a separate backing plate extending across each of said trays.

20. A tissue box cover according to claim 18 further comprising a mounting stand that includes a stationary support and a platform located atop said stationary support and mounted for rotation relative thereto about a central, vertical axis of rotation, and said upright walls are seated upon said platform.
